(19) United States
(12) Patent Application Publication
(10) Pub. No.: US 2002/0127465 A1
(43) Pub. Date: Sep. 12, 2002

(54) Component such as a cell frame and/or a pole plate for a PEM fuel cell with a reduced contact resistance, and method for reducing the contact resistance

(76) Inventors: Heinz Forderer, Grosskrotzenburg (DE); Regina Hornung, Erlangen (DE); Bernd Jeschonnek, Erlensee (DE); Manfred Waidhas, Nurnberg (DE)

Correspondence Address: LERNER AND GREENBERG, P.A., PATTENT ATTORNEYS AND ATTORNEYS AT LAW, Post Office Box 2480, Hollywood, FL, 33022-2480, US

(21) Appl. No.: 09/968,588

(22) Filed: Oct. 1, 2001

Related U.S. Application Data
(63) Continuation-in-part of application No. PCT/DE00/00717, filed on Mar. 7, 2000.

(30) Foreign Application Priority Data
Mar. 29, 1999 (DE) 199 14 250.5

(51) Int. Cl. H01M 4/86; B05D 5/12; H01M 8/02

(52) U.S. Cl. 429/44; 429/34; 427/115

(57) ABSTRACT

A method and a fuel cell are described in which it is possible to combine the advantages of a precious-metal coating, which, for example, reduces the contact resistance between a pole plate and current collector of a fuel cell, with low production costs. This becomes possible since it has been established that a sufficient and sometimes even improved reduction in the contact resistance of a component to a contact element is achieved even with a minimal precious-metal coating that is not continuous.

### CROSS-REFERENCE TO RELATED APPLICATION

This application is a continuation of copending International Application No. PCT/DEOO/00717, filed Mar. 7, 2000, which designated the United States.

### BACKGROUND OF THE INVENTION

1. Field of the Invention:

The invention relates to a fuel cell having at least one component such as a cell frame and/or a pole plate with a coated surface and a reduced contact resistance. In addition, the invention relates to a method for reducing the contact resistance.

German Patent DE 44 42 285 C1 and Published, Non-Prosecuted German Patent Application DE 197 02 119 A1 disclose cell frames and pole plates for proton-conducting electrolyte membrane (PEM) fuel cells made from corrosion-resistant materials. These are Fe-based materials, which provide advantages in terms of manufacturing technology. The corrosion resistance of these materials is attributable to the formation of a passivation oxide layer, which, however, drastically increases the contact resistance between the current collector and the pole plate, so that considerable voltage losses occur. To reduce the contact resistance the pole plate is, for example, homogeneously gold-plated with a layer thickness≧0.5 μum or is coated with some other precious metal.

Gold-plated layers are usually continuous. The coating is normally carried out to a layer thickness of up to 0.5 μm. As a corollary to this relatively thick application of precious metal, the costs of the surface coating are very high. German Patent DE 69 125 425 T2 discloses a thin-film gold plating for superconductors, in which a homogeneous protective precious-metal layer is applied between two super conducting layers.

However, the demands imposed on the latter protective layer are different from those imposed on an electrically conductive layer for reducing the contact resistance. Therefore, the known layer has a specific profile of properties, for example with regard to the electrical conductivity and to the contact resistance. In this case, a different production method is also employed.

U.S. Pat. No. 5,549,808 discloses a method for coating contacts in which layers of good electrical conductivity in the micron or sub micron range are applied to the contacts. Specifically, these are contacts for semiconductor structures.

### SUMMARY OF THE INVENTION

It is accordingly an object of the invention to provide a component such as a cell frame and/or a pole plate for a PEM fuel cell with a reduced contact resistance, and a method for reducing the contact resistance that overcome the above-mentioned disadvantages of the prior art devices and methods of this general type, which reduces the costs of the precious-metal surface coating of the component and, at the same time, minimizes the contact resistance on the component.

With the foregoing and other objects in view there is provided, in accordance with the invention, a fuel cell. The fuel cell contains at least one component made from a corrosion-resistant material, and a precious-metal contact layer disposed on at least one part of the component for reducing a contact resistance. The precious-metal contact layer has a mean thickness of ≦0.3 μm, and the precious-metal contact layer forms discrete conduction paths and/or conduction islands. The mean thickness can vary significantly and can be ≦0.05 μm, be between 1 and 10 nm, be ≦0.1 μm or be ≦0.2 μm.

In accordance with an added feature of the invention, the precious-metal contact layer is formed from gold.

In accordance with another feature of the invention, the component is a pole plate or a cell frame.

With the foregoing and other objects in view there is further provided, in accordance with the invention, a method for reducing a contact resistance of components of a fuel cell. The method includes coating a component with a precious metal, the precious metal being applied as at least one of discrete conduction paths and conduction islands with a layer thickness of at most 0.1 μm.

In accordance with an additional mode of the invention, there is the step of using a continuous process sequence for applying the coating.

In accordance with a further mode of the invention, there is the step of coating selectively, only certain locations and/or sides of the component.

Other features which are considered as characteristic for the invention are set forth in the appended claims.

Although the invention is described herein as embodied in a component such as a cell frame and/or a pole plate for a PEM fuel cell with a reduced contact resistance, and a method for reducing the contact resistance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### PREFERRED EMBODIMENT OF THE INVENTION

The invention provides a fuel cell, in particular a PEM fuel cell, in which a precious-metal contact layer is present on at least one location and/or side on a component made from a corrosion resistant material, such as a pole plate and/or a cell frame. In this case, the mean thickness of the precious-metal contact layer is at least 0.1 μm. The layer thickness may be less than 0.05 μm and, if appropriate, less than 0.3 μm or even 0.2 μm.

In particular, the layer thickness may lie in the range between 1 and 10 nm (0.01 μm), i.e. in the nano range.

The invention also relates to a method for reducing the contact resistance of a component by coating with precious metal, the precious-metal layer being applied with a layer thickness of at most 0.1 μm.

The method according to the invention results in a reduction in the contact resistance of the fuel-cell component by coating with a precious metal, the precious-metal layer being applied with a layer thickness of at most 0.1 μm.

In the present context, the term “coating” preferably does not denote a continuous, homogeneous, cohesive, dense (pinhole-free) and/or surface-covering coating, but rather a coating of the component which at least contains discrete and shallow islands and/or paths of the corresponding precious-metal atoms.

The discrete islands and/or paths of the coating are referred to as conduction islands and/or conduction paths, since they, unlike the surrounding normal surface of the component, which generally has a passivation oxide layer, are regions of the component which have a low resistance.

The minimum conduction island and/or conduction path density and/or the minimum coverage with the precious-metal atoms in the coating is that at which a sufficient number of conductivity paths permeates the existing passive/oxide layer of the coated component, so that the macroscopic contact resistance falls below 20 mΩcm².

The term “mean thickness of precious-metal contact layer” and/or “layer thickness” denotes a theoretical height that would result if a homogeneous distribution of the conduction paths which under certain circumstances are present as discrete paths were to be assumed. For example, in the case of a mean height of the conduction paths of 0.17 μm and a 30% coverage, this calculation results in a “mean thickness of the precious-metal contact layer” of 0.051 μm.

Further examples for the calculation of the mean thickness are:

| Mean height of the conduction paths: | | | 0.17 μm; |
|---|---|---|---|
| Coverage | 18%: | mean thickness: | 0.03 μm; |
| | 50%: | | 0.09 μm |
| | 10%: | | 0.017 μm |
| Mean coverage: | 20% | | |
| Height of the | 0.15 μm: | Mean thickness: | 0.03 μm |
| conduction paths: | 0.10 μm: | | 0.02 μm |
| | 0.20 μm: | | 0.04 μm |

The layer thickness applied using the method is preferably less than or equal to 0.1 μm, preferably less than or equal to 0.05 μm, and particularly preferably less that or equal to 0.03 μm. A layer thickness of less than 0.02 μm are also used. In one embodiment, a layer thickness of 0.015 μm was achieved.

According to one configuration of the method, the precious-metal coating is applied electrochemically by one-off contact with the pole plate and/or the cell frame. The surface of the component to be coated is, as it were, activated by the precious metal, so that the contact resistance of the component to another contact element becomes low, and ideally tends toward zero.

According to one configuration of the invention, the precious-metal coating of the component, of the pole plate and/or of the cell frame does not cover the entire surface, so that the precious-metal coating contains discrete conduction paths and/or conduction islands.

According to another advantageous configuration of the invention, the contact layer contains a continuous layer of precious metal, for example a layer of gold in the nano range (for example 1 to 10 nm).

According to a further configuration of the invention, not all sides of the component are coated with precious metal, so that, for example, a precious-metal coating is only applied to the side at which a current transition from a current collector to the pole plate takes place. It is also possible for only a certain region of one or more sides of the component to be coated.

The precious metals used are preferably gold, silver, palladium, copper, rhodium, iridium and platinum, as well as any appropriate alloys and mixtures of these metals.

Through suitable pre-activation and subsequent preliminary gold plating, the method makes it possible to produce what is known as the preliminary contact gold, i.e. an application that is distinguished by an extremely small thickness of the precious-metal coating, allowing the consumption of precious metal and therefore the costs of the surface treatment to be reduced considerably.

The use of brush plating (inter alia in combination with pressure contact gold plating) makes it possible to selectively gold-plate only one side, for example that side of the pole plate and/or of the cell frame which faces the anode chamber or cathode chamber, while the other side of the pole plate, i.e. for example the side which faces the cooling circuit, remains free of coating.

During brush plating, a mask that protects the masked parts of the pole plate from the coating is laid onto the component that is to be coated. After the contact coating has taken place, the mask is then removed again.

In a further configuration of the method, the component is coated in a continuous and automated method, making the method suitable for mass production.

When using a configuration of the invention, it has been possible to achieve a contact resistance between a pole plate and a current collector of less than 3 mΩcm² (at a pressure of 16 bar) or of 7 mΩcm² (at 4 bar).

The invention makes it possible to combine the advantages of precious-metal coating, which, for example, reduces the contact resistance between the pole plate and the current collector of a fuel cell, with low production costs. This is possible because it has been established that a sufficient and sometimes even improved reduction in the contact resistance between a component and a contact element is achieved even with a minimal, by no means continuous precious-metal coating. The coating may be so thin that, under certain circumstances, it is invisible to the naked eye.

We claim:

1. A fuel cell, comprising:
at least one component made from a corrosion-resistant material; and
a precious-metal contact layer disposed on at least one part of said component for reducing a contact resistance, said precious-metal contact layer having a mean thickness of ≦0.3 μm, and said precious-metal contact layer forming at least one of discrete conduction paths and conduction islands.

2. The fuel cell according to claim 1, wherein said mean thickness is ≦0.05 μm.

3. The fuel cell according to claim 2, wherein said mean thickness is between 1 and 10 nm.

4. The fuel cell accordin to claim 1, wherein said precious-metal contact layer is formed from gold.

5. The fuel cell according to claim 1, wherein said component is a pole plate.

6. The fuel cell according to claim 1, wherein said component is a cell frame.

7. The fuel cell according to claim 1, wherein said mean thickness is ≦0.1 μm.

8. The fuel cell according to claim 1, wherein said mean thickness is ≦0.2 μm.

9. A method for reducing a contact resistance of components of a fuel cell, which comprises the steps of:
coating a component with a precious metal, the precious metal being applied as at least one of discrete conduction paths and conduction islands with a layer thickness of at most 0.1 μm.

10. The method according to claim 9, which comprises using a continuous process sequence for applying the coating.

11. The method according to claim 9, which comprises using gold as the precious metal.

12. The method according to claim 9, which comprises coating selectively, only certain locations and/or sides of the component.

13. The method according to claim 9, which comprises providing a pole plate as the component.

14. The method according to claim 9, which comprises providing a cell frame as the component.
